(19) United States
(12) Patent Application Publication
(10) Pub. No.: US 2011/0277513 A1
(43) Pub. Date: Nov. 17, 2011

(54) Washing machine having drying function and water filter thereof

(75) Inventors: Seong Min Oak, Hwaseong-si (KR); Phil Soo Chang, Seongnam-si (KR); Min Hee Kang, Suwon-si (KR)

(73) Assignee: SAMSUNG ELECTRONICS CO., LTD., Suwon-si (KR)

(21) Appl. No.: 12/929,763

(22) Filed: Feb. 14, 2011

(30) Foreign Application Priority Data
May 11, 2010 (KR) 10-2010-0043913

(51) Int. Cl. D06F 35/00; B01D 50/00

(52) U.S. Cl. 68/20; 137/1; 55/385.1

(57) ABSTRACT

A washing machine includes a main body, a drum disposed within the main body, an air supply duct disposed so as to be communicated with the drum, and supplying hot air to the inside of the drum, a first exhaust duct communicated with the drum so as to exhaust the hot air from the drum, a second exhaust duct to guide the hot air exhausted from the drum to the outside of the main body, a filter case provided with a hot air introduction hole connected to the first exhaust duct and a hot air exhaust hole connected to the second exhaust duct, a water storage chamber provided within the filter case, and a hot air flow chamber provided within the filter case and communicated with the water storage chamber.

### CROSS-REFERENCE TO RELATED APPLICATIONS

This application claims the benefit of Korean Patent Application No. 2010-0043913, filed on May 11, 2010 in the Korean Intellectual Property Office, the disclosure of which is incorporated herein by reference.

### BACKGROUND

1. Field

Embodiments relate to a washing machine having a water filter to collect lint from exhausted hot air.

2. Description of the Related Art

In general, a washing machine is an apparatus which washes laundry using frictional force between the laundry and washing water. As one kind out of various kinds of washing machines, there is a drum washing machine. Hereinafter, the drum washing machine will be exemplarily described.

Recently, various functions are being added to drum washing machines, and thus a drying function to dry laundry using hot air is proposed. Drum washing machines having such a drying function are divided into a condensation type and a ventilation type.

A condensation type drum washing machine transmits hot air generated from a heater to a drum through an air blower fan so as to dry laundry in the drum. High-temperature and high-humidity air after drying the laundry is transmitted to an exhaust hole communicated with a tub, cold water is sprayed onto the high-temperature and high-humidity air to remove moisture from the air, and then the air from which moisture is removed is re-supplied to the air blower fan.

Here, low-temperature condensation water is continually discharged during a drying cycle and thus a large amount of condensation water is used, and air from which moisture is not sufficiently removed through condensation is re-heated by the heater and supplied to the inside of the drum and thus drying efficiency is lowered. Further, when humid air from which moisture is not removed is re-supplied to the heater, electric stability of the heater may be deteriorated.

A ventilation type drum washing machine allows hot air generated from a heater to pass through laundry in a drum, and then discharges the hot air to the outside of the washing machine through an exhaust hole formed at one side of the washing machine. At this time, lint (fine nap) together with the hot air is discharged to the outside of the washing machine. When the ventilation type drum washing machine is used for a long time, the lint is deposited in the exhaust hole and clogs the exhaust hole. Therefore, a filter to collect the lint is installed in front of the exhaust hole.

### SUMMARY

Therefore, it is an aspect to provide a water filter to collect lint discharged together with hot air, and a washing machine having the same.

Additional aspects will be set forth in part in the description which follows and, in part, will be apparent from the description, or may be learned by practice of the invention.

In accordance with one aspect, a washing machine includes a main body, a drum disposed within the main body, an air supply duct disposed so as to be communicated with the drum, and supplying hot air to the inside of the drum, a first exhaust duct communicated with the drum so as to exhaust the hot air from the drum, a second exhaust duct to guide the hot air exhausted from the drum to the outside of the main body, a filter case provided with a hot air introduction hole connected to the first exhaust duct and a hot air exhaust hole connected to the second exhaust duct, a water storage chamber provided within the filter case, and a hot air flow chamber provided within the filter case and communicated with the water storage chamber.

The hot air introduction hole may be formed through the upper surface of the hot air flow chamber, and guide the hot air introduced through the hot air introduction hole toward the upper surface of the water storage chamber.

The hot air introduction hole may be formed at one end of the hot air flow chamber and the hot air exhaust hole may be formed at the other end of the hot air flow chamber so as to allow the hot air to flow from the one end of the hot air flow chamber to the other end of the hot air flow chamber.

The hot air flow chamber may include a hot air introduction chamber provided with one side communicated with the hot air introduction hole and a hot air discharge chamber provided with one side communicated with the hot air introduction chamber and the other side communicated with the hot air exhaust hole, lower surfaces of the hot air introduction chamber and the hot air discharge chamber may be opened to be communicated with the water storage chamber, and the washing machine may further include a hot air vent formed between the hot air introduction chamber and the hot air discharge chamber.

A cross-sectional area of the hot air vent may be smaller than a cross-sectional area of the hot air introduction hole.

An inner upper surface of the hot air introduction chamber may be inclined at a designated angle toward the water storage chamber so as to guide the hot air introduced through the hot air introduction hole toward the water storage chamber.

The washing machine may further include a drain hole formed through the water storage chamber to discharge water from the water storage chamber to the outside.

The washing machine may further include a drain pump to absorb washing water and then to discharge the washing water to the outside of the main body, and the drain hole may be connected to a washing water inlet of the drain pump.

The washing machine may further include a water filter drain valve connected with the drain hole.

The drain pump may absorb the water stored in the water storage chamber and then discharge the water to the outside of the main body under the condition that the water filter drain valve is opened.

The washing machine may further include at least one hot air guide grid fixed to the upper surface of the hot air flow chamber and extended toward the water storage chamber.

The at least one hot air guide grid may form a vent path in the hot air flow chamber, and the vent path may be provided with one side communicated with the hot air introduction hole and the other side communicated with the hot air exhaust hole and have a distance being at least longer than a rectilinear distance from the hot air introduction hole to the hot air exhaust hole.

A lower surface of the at least one hot air guide grid may be located at a higher position than the upper surface of the water storage chamber.

The washing machine may further include a plurality of water spray holes formed on the inner upper surface of the hot air flow chamber.

In accordance with another aspect, a water filter for washing machines includes a filter case forming an external appearance of the water filter, a water storage chamber, an upper surface of which is opened, provided in the lower portion of the inside of the filter case, a hot air flow chamber, a lower surface of which is opened, provided in the upper portion of the inside of the filter case, a hot air introduction hole formed at one side of the hot air flow chamber, and a hot air exhaust hole formed at the other side of the hot air flow chamber.

The hot air flow chamber may include a hot air introduction chamber provided with one side communicated with the hot air introduction hole and a hot air discharge chamber provided with one side communicated with the hot air introduction chamber and the other side communicated with the hot air exhaust hole, lower surfaces of the hot air introduction chamber and the hot air discharge chamber may be opened to be communicated with the water storage chamber, and the water filter for washing machines may further include a hot air vent formed between the hot air introduction chamber and the hot air discharge chamber.

A cross-sectional area of the hot air vent may be smaller than a cross-sectional area of the hot air introduction hole.

An inner upper surface of the hot air introduction chamber may be inclined at a designated angle toward the water storage chamber so as to guide the hot air introduced through the hot air introduction hole toward the water storage chamber.

The water filter for washing machines may further include a drain hole formed through the water storage chamber to discharge water from the water storage chamber to the outside.

The water filter for washing machines may further include at least one hot air guide grid fixed to the upper surface of the hot air flow chamber and extended toward the water storage chamber.

The water filter for washing machines may further include a plurality of water spray holes formed on the inner upper surface of the hot air flow chamber.

In accordance with a further aspect, a control method of a drying cycle of a washing machine having a water filter to remove lint from hot air discharged from a drum, includes closing a water filter drain valve connected to a drain hole of the water filter, supplying water to the water filter through a water supply hole of the water filter, and opening the water filter drain valve and operating a drain pump, when drying of laundry is completed, to discharge the water in the water filter to the outside of a main body of the washing machine.

### BRIEF DESCRIPTION OF THE DRAWINGS

These and/or other aspects will become apparent and more readily appreciated from the following description of the embodiments, taken in conjunction with the accompanying drawings of which:

FIG. 1 is a view illustrating a configuration of a washing machine in accordance with one embodiment;

FIG. 2 is a perspective view of a water filter of the washing machine in accordance with the embodiment;

FIG. 3A is a sectional view of the water filter, taken along the line I-I of FIG. 2;

FIG. 3B is a sectional view of the water filter, taken along the line II-II of FIG. 2;

FIG. 4A is a sectional view of a water filter in accordance with another embodiment, taken along the line I-I of FIG. 2;

FIG. 4B is a sectional view of a water filter in accordance with another embodiment, taken along the line I-I of FIG. 2;

FIG. 5A is a sectional view of a water filter in accordance with another embodiment, taken along the line I-I of FIG. 2;

FIG. 5B is a sectional view of the water filter in accordance with the embodiment, taken along the line of FIG. 2;

FIG. 6 is a sectional view of a water filter in accordance with a further embodiment, taken along the line I-I of FIG. 2; and

FIGS. 7 and 8 are views illustrating operation of a water filter of a washing machine in accordance with one embodiment.

### DETAILED DESCRIPTION

Reference will now be made in detail to the embodiments, examples of which are illustrated in the accompanying drawings, wherein like reference numerals refer to like elements throughout.

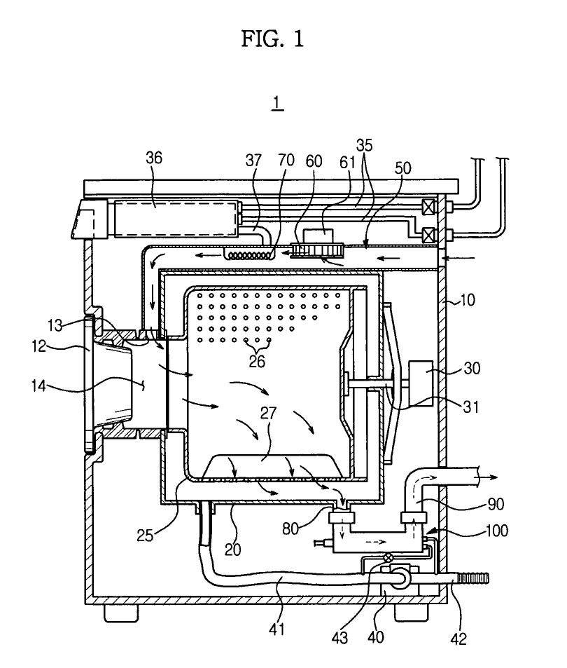

FIG. 1 is a view illustrating a configuration of a washing machine in accordance with one embodiment.

As shown in FIG. 1, a washing machine 1 includes a main body 10 forming an external appearance of the washing machine 1, a tub 20 disposed in the main body 10, a drum 25 rotatably disposed in the tub 20, and a motor 30 to rotate the drum 25.

An inlet through which laundry is put into the drum 25 is formed through the front surface of the main body 10. The inlet 14 is opened and closed by a door 12 installed at the front surface of the main body 10.

Water supply pipes 35 to supply washing water to the tub 20 are installed above the tub 20. One end of each of the water supply pipes 35 is connected to an external water supply source (not shown), and the other end of each of the water supply pipes 35 is connected to a detergent supply device 36.

The detergent supply device 36 is connected to the tub 20 through a connection pipe 37. Water supplied through the water supply pipes 35 is supplied to the inside of the tub 20 together with a detergent via the detergent supply device 36.

A drain pump 40, a drain pipe 41, and a drain hose 42 to discharge water in the tub 20 to the outside of the main body 10 are installed below the tub 20.

A plurality of through holes 26 to circulate the washing water is formed through the circumferential surface of the drum 25, and a plurality of lifters 27 to raise and drop laundry when the drum 25 is rotated is installed on the inner circumferential surface.

A driving shaft 31 is disposed between the drum 25 and the motor 30. When the motor 30 drives the driving shaft 31, the drum 25 connected to the driving shaft 31 is rotated around the driving shaft 31.

The motor 30 rotates the drum 25 at a low speed in regular and reverse directions during a washing cycle, and thereby the laundry in the drum 25 is continually tumbled and contaminants are removed from the laundry. Further, when the motor 30 rotates the drum 25 at a high speed in one direction during a spin-drying cycle, water is separated from the laundry by means of centrifugal force applied to the laundry.

An air supply duct 50 to supply high-temperature air to the laundry contained in the drum 25 to dry the laundry having completed the washing cycle is installed above the tub 20. One end of the air supply duct 50 is communicated with the outside of the drum 25, and the other end of the air supply duct 50 is connected to an inlet 13 provided on the front surface part of the tub 20 so as to be communicated with the drum 25. As air at the outside of the drum 25 passes through the air supply duct 50, the air is heated. One end of the air supply duct 50 may be communicated directly with the outside of the main body 10.

An air blower fan 60 is installed in the air supply duct 50. The air blower fan 60 causes the air at the outside of the drum 25 to be introduced into the air supply duct 50 and then to be discharged to the inside of the drum 25. Further, a fan motor 61 is located around the air blower fan 60 and rotates the air blower fan 60.

A heater 70 using resistance heat is installed in the air supply duct 50. The heater 70 is formed in a zigzag shape, and is disposed throughout the entire width of a passage in the air supply duct 50. Although the heater 70 may be disposed at the front end or the rear end of the air blower fan 60, the heater 70 is disposed at the rear end of the air blower fan 60 in this embodiment of the present invention.

A first exhaust duct 80 is disposed so as to be communicated with the drum 25. The hot air supplied to the inside of the drum 25 dries the laundry within the drum 25, and then is exhausted to the first exhaust duct 80 via the plural through holes 26. The first exhaust duct 80 may be installed on the lower surface part or the rear surface part of the tub 20. A switching device (not shown), such as a valve, is provided in the first exhaust duct 80 so as to prevent the washing water stored in the tub 20 from being introduced into the first exhaust duct 80.

A second exhaust duct 90 is disposed so as to guide the hot air exhausted from the drum 25 to the outside of the main body 10. The hot air of the drum 25 exhausted to the first exhaust duct 80 is discharged to the outside of the main body 10 through the second exhaust duct 90. The second exhaust duct 90 is connected to the rear surface of the main body 10.

The hot air discharged to the outside of the drum 25 contains lint generated from a drying process. When the washing machine 1 is used for a long time, the lint is deposited in the first exhaust duct 80 and the second exhaust duct 90, thereby reducing drying efficiency and causing a fire hazard.

Therefore, the washing machine 1 further includes a water filter 100 to collect lint from hot air discharged to the outside of the main body 10.

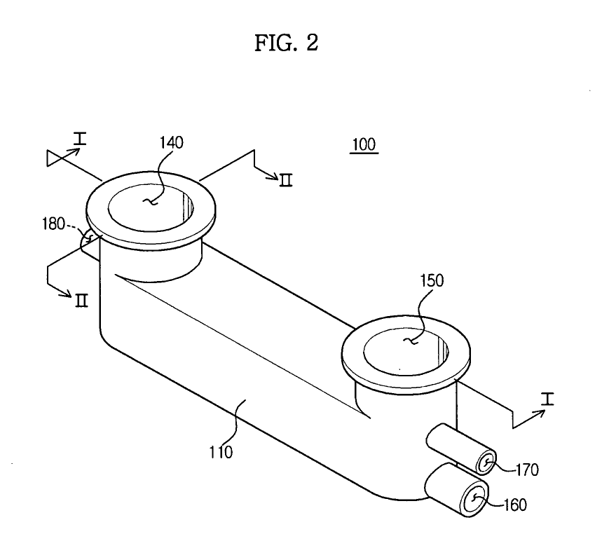

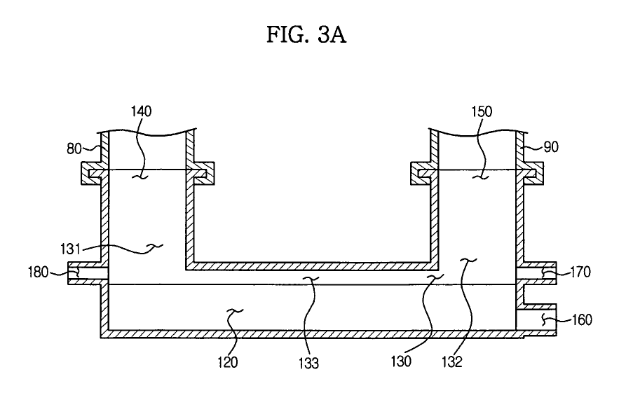

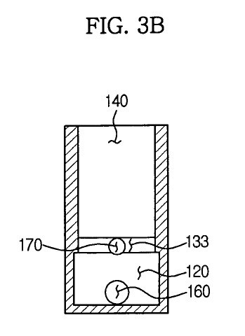

FIG. 2 is a perspective view of a water filter of the washing machine in accordance with the embodiment, FIG. 3A is a sectional view of the water filter, taken along the line I-I of FIG. 2, and FIG. 3B is a sectional view of the water filter, taken along the line II-II of FIG. 2.

The water filter 100 is disposed between the first exhaust duct 80 and the second exhaust duct 90. The water filter 100 is detachably installed on the first exhaust duct 80 and the second exhaust duct 90.

When hot air containing lint is introduced into the water filter 100, the hot air flows within the water filter 100 while contacting the surface of water stored in the water filter 100, and the water filter 100 collects the lint from the hot air and then discharges the hot air from which the lint is removed to the outside of the water filter 100.

The water filter 100 includes a filter case 110 forming an external appearance of the water filter 100, a water storage chamber 120 storing water to collect the lint, a hot air flow chamber 130 in which the hot air flows while contacting the water, a hot air introduction hole 140 through which the hot air is introduced into the water filter 100, and a hot air exhaust hole 150 through which the hot air is discharged to the outside of the water filter 100. The water filter 100 further includes a water supply hole 180 to supply water to the water storage chamber 120, and a water level adjustment hole 170 to adjust a water level of the water storage chamber 120. The filter case 110 corresponds to a body of the water filter 100, and is disposed between the first exhaust duct 80 and the second exhaust duct 90.

The water storage chamber 120 is provided in the lower portion of the inside of the filter case 110. Water is supplied to the water storage chamber 120 before the drying cycle is started. The upper surface of the water storage chamber 120 is opened such that hot air flowing on a water surface and water are in contact with each other and lint contained in the hot air is collected in the water.

When the lint is collected by the water filter 100 through the drying cycle, it is required to discharge the water in the water storage chamber 120 to the outside of the main body 10. For this purpose, a drain hole 160 is formed on the lower surface part or the side surface part of the water storage chamber 120. The drain hole 160 is connected to the drain pipe 41, and the water and lint stored in the water storage chamber 120 are discharged to the outside of the main body 10 through the drain pipe 41 by the drain pump 40. Since the drain pipe 160 is closed while the drying cycle is carried out, a water filter drain valve 43 is provided between the drain hole 160 and the drain pipe 41. The drain hole 160 may be connected to the drain hose 42 or may be connected directly to the outside of the main body 10. If the drain hole 160 is formed on the side surface part of the water storage chamber 120, the drain hole 160 is disposed at the lowermost position of the side surface part of the water storage chamber 120 so as to drain all amount of the water stored in the water storage chamber 120. The collected lint is easily removed from the main body 10 by draining the water from the water filter 100, thereby allowing the water filter 100 to be easily maintained and repaired.

The hot air flow chamber 130 is provided in the upper portion of the inside of the filter case 110. The lower surface of the hot air flow chamber 130 is opened, and thus is communicated with the opened front surface of the water storage chamber 120. That is, the lower surface of the hot air flow chamber 130 and the upper surface of the water storage chamber 120 are opened with respect to each other. As the hot air flows from one side to the other side of the hot air flow chamber 130, the hot air contacts the surface of the water filling the water storage chamber 120 and thus filtering-off of the lint is achieved.

The hot air introduction hole 140 is formed at one side of the hot air flow chamber 130, and the hot air exhaust hole 150 is formed at the other side of the hot air flow chamber 130. The hot air introduction hole 140 and the hot air exhaust hole 150 correspond to an inlet and an outlet of the hot air flow chamber 130, respectively. The hot air introduction hole 140 is connected to the first exhaust duct 80 such that the hot air containing lint through drying of the laundry passes through the first exhaust duct 80 and is introduced into the water filter 100 through the hot air introduction hole 140. Further, the hot air exhaust hole 150 is connected to the second exhaust duct 90 such that the hot air from which the lint is removed via the hot air flow chamber 130 is exhausted to the outside of the main body 10.

The lint contained in the hot air is collected in water through contact between the hot air and the water, and thus it is required to guide the hot air in a direction of the water surface. Therefore, the hot air introduction hole 140 is formed on the upper surface of the hot air flow chamber 130 so as to guide the hot air toward the upper surface of the water storage chamber 120. Further, in order to cause the hot air to be in contact with water while flowing from one side end of the hot air flow chamber 130 to the other side end of the hot air flow chamber 130, the hot air introduction hole 140 may be formed at one end of the hot air flow chamber 130 and the hot air exhaust hole 150 may be formed at the other end of the hot air flow chamber 130 so as to increase collection efficiency of lint.

The hot air flow chamber 130 includes a hot air introduction chamber 131 provided with one side communicated with the hot air introduction hole 140, and a hot air discharge chamber 132 provided with one side communicated with the hot air introduction chamber 131 and the other side communicated with the hot air exhaust hole 150. Further, a hot air vent 133 is formed between the hot air introduction chamber 131 and the hot air discharge chamber 132. The lower surface of the hot air introduction chamber 131 and the lower surface of the hot air discharge chamber 132 are opened with respect to the upper surface of the water storage chamber 120 in the same manner as the hot air flow chamber 131.

All amount of hot air containing lint introduced into the hot air introduction chamber 131 flows to the hot air discharge chamber 132 through the hot air vent 133. The hot air vent 133 is configured such that a cross-sectional area of the hot air vent 133 is smaller than a cross-sectional area of the hot air introduction chamber 131. Therefore, the velocity of the hot air when the hot air passes through the hot air vent 133 is increased compared with the velocity of the hot air when the hot air passes through the hot air introduction chamber 140, and the collection efficiency of the lint around the hot air vent 133 is increased.

In order to uniformly maintain the level of the water stored in the water storage chamber 120, the water level adjustment hole 170 is formed at one side of the hot air flow chamber 130. When the lint is collected in the water stored in the water storage chamber 120 during the drying cycle, the water level may be raised as much as the volume of the collected lint. When the hot air vent 133 is closed by the water with the raised level, the drying cycle is not carried out any more. Therefore, it is required to prevent the water level from being raised above a designated height. The water level adjustment hole 170 is disposed around the water storage chamber 120. The water level adjustment hole 170 is connected to the drain hose 42, and water introduced into the water level adjustment hole 170 is discharged to the outside of the main body 10 through the drain hose 42. Further, the water level adjustment hole 170 may be connected directly to the outside of the main body 10.

The water supply hole 180 is formed at one side of the filter case 110. Before drying of laundry is started, water required to collect lint is supplied to the water storage chamber 120 through the water supply hole 180. A separate water supply device (not shown) may be connected to the water supply hole 180, or the connection pipe 37 to supply washing water to the tub 20 may be branched and the branched part of the connection pipe 37 may be connected to the water supply hole 180. Even if an amount of water exceeding a necessary amount is supplied to the water storage chamber 120 through the water supply hole 180, a proper water level is maintained through the water level adjustment hole 170.

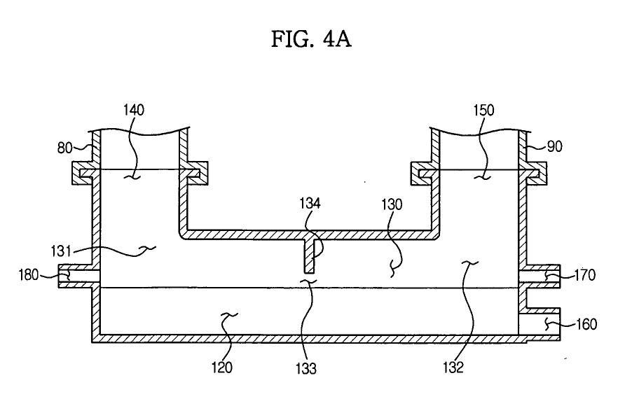

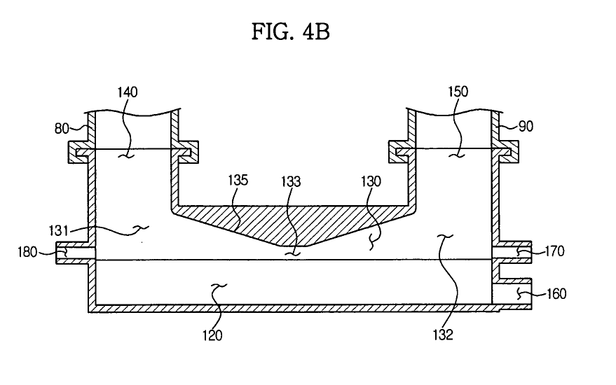

FIG. 4A is a sectional view of a water filter in accordance with another embodiment, taken along the line I-I of FIG. 2, and FIG. 4B is a sectional view of a water filter in accordance with another embodiment, taken along the line I-I of FIG. 2.

As shown in FIG. 4A, a diaphragm 134 is provided between the hot air introduction chamber 131 and the hot air discharge chamber 132. One side of the diaphragm 134 is fixed to the upper portion of the inside of the hot air flow chamber 130, and the other side of the diaphragm 134 is extended toward the water storage chamber 120. At least a part of the lower surface of the diaphragm 134 is located at a higher position than the upper surface of the water storage chamber 120 so as to communicate the hot air introduction chamber 131 and the hot air discharge chamber 132 with each other. Here, the hot air vent 133 is provided between the lower surface of the diaphragm 134 and the surface of water stored in the water storage chamber 120.

As shown in FIG. 4B, in order to guide hot air introduced into the hot air introduction hole 140 to the water surface, the upper surface of the inside of the hot air introduction chamber 131 is inclined toward the water storage chamber 120 at a designated angle, thus forming an inclined plane 135. The inclined plane 135 is formed from the hot air introduction hole 140 to the hot air vent 133, and guides the hot air, flowing from the hot air introduction chamber 131 to the hot air discharge chamber 132, to the water surface. The hot air comes in firm contact with the water surface, and thus the collection efficiency of the lint is raised.

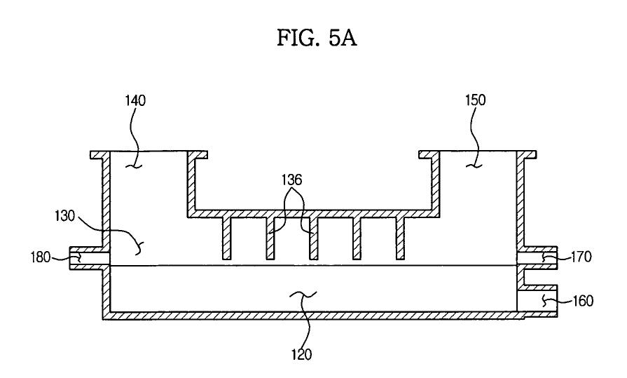

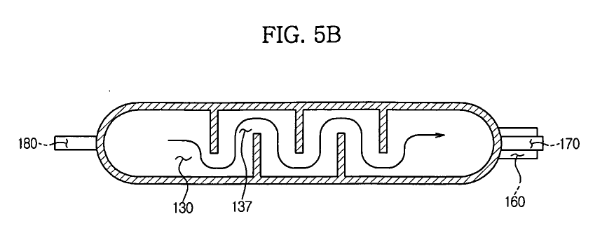

FIG. 5A is a sectional view of a water filter in accordance with another embodiment of the present invention, taken along the line I-I of FIG. 2, and FIG. 5B is a sectional view of the water filter in accordance with the embodiment of the present invention, taken along the line III-III of FIG. 2.

Hot air guide grids 136 are installed in the hot air flow chamber 130 to increase a flow distance of the hot air within the hot air flow chamber 130. One side of each of the hot air guide grids 136 is fixed to the upper surface of the inside of the hot air flow chamber 130, and the other side of each of the hot air guide grids 136 is extended toward the water storage chamber 120. Even if the hot air guide grids 136 are installed, the lower surface of the hot air flow chamber 130 and the upper surface of the water storage chamber 120 maintain the opened state with respect to each other. If needed, a plurality of hot air guide grids 136 may be installed.

The hot air guide grids 136 are disposed such that a vent path 137 provided with one side communicated with the hot air introduction hole 140 and the other side communicated with the hot air exhaust hole 150 is formed in the hot air flow chamber 130. A distance of the vent path 137 is at least longer than a rectilinear distance from the hot air introduction hole 140 to the hot air exhaust hole 150. Accordingly, the distance, through which hot air containing lint contacts a water surface, increases, and thus the collection efficiency of the lint is raised.

The lower surfaces of the hot air guide grids 136 may be located at a higher position than the upper surface of the water storage chamber 120. If a part of each of the hot air guide grids 136 is submerged in the water, the hot air guide grids 136 obstruct a water flow and thus influence collection of the lint on the water surface.

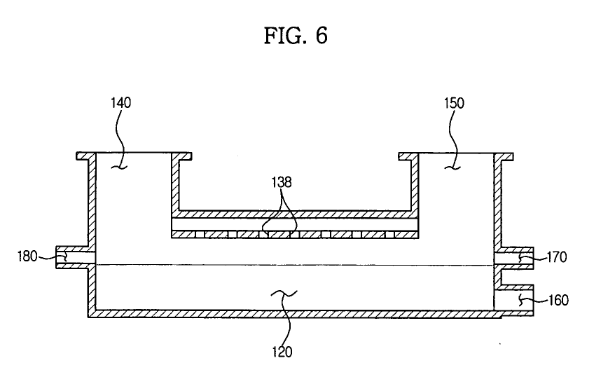

FIG. 6 is a sectional view of a water filter in accordance with another embodiment, taken along the line I-I of FIG. 2.

The water filter 100 may spray water onto hot air flowing in the hot air flow chamber 130 so as to raise collection efficiency of lint. For this purpose, water spray holes 138 are formed through the upper surface of the inside of the hot air flow chamber 130. If needed, a plurality of water spray holes 138 may be formed.

Water sprayed through the water spray holes 138 sticks to the lint contained in hot air, thereby causing the lint to be dropped down to the water storage chamber 120. Water supplied to the water spray holes 138 may be supplied separately, or may be supplied through circulation of water filling the water storage chamber 120.

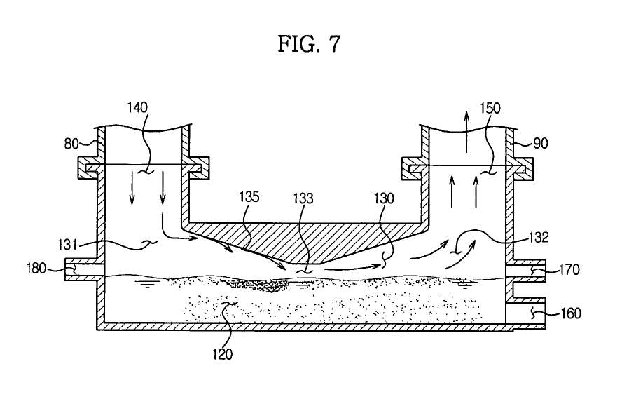

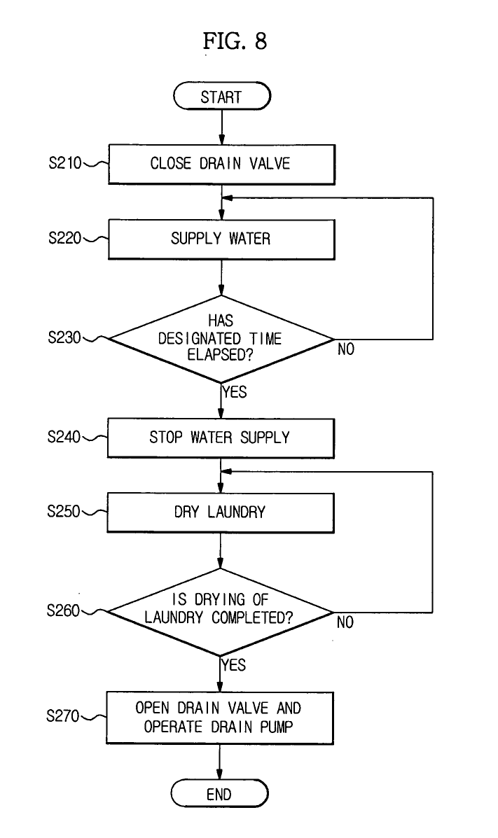

FIGS. 7 and 8 are views illustrating operation of a water filter of a washing machine in accordance with one embodiment.

When a drying cycle is started, the water filter drain valve 43 is closed (operation S210), and water is supplied to the water storage chamber 120 through the water supply hole 180 (operation S220). If a designated time has elapsed and a proper level of water fills the water storage chamber 120 (operation S230), water supply is stopped (operation S240). Here, a user may separate the water filter 100 from the main body 10 and then supply water directly to the water storage chamber 120 not through the water supply hole 180.

When drying of laundry is started, hot air of high-temperature and low-humidity is supplied to the drum 25 through the air supply duct 50. The hot air having passed through the inside of the drum 25 passes through the first exhaust duct 80, and is introduced into the hot air introduction chamber 131 through the hot air introduction hole 140. The hot air introduced into the hot air introduction chamber 131 contains lint generated from laundry during the drying cycle. Such hot air flows to the hot air discharge chamber 132 through the hot air vent 133. The hot air comes in contact with a water surface during this process. The hot air flows toward the water surface by means of the inclined plane 135, and the velocity of the hot air in the hot air vent 133 is increased and the hot air comes in firm contact with the water surface, since the cross-sectional area of the hot air vent 133 is smaller than the cross-sectional area of the hot air introduction hole 140. Therefore, collection of the lint in the water is concentrated around the hot air vent 133. The hot air, from which the lint is removed by the hot air vent 133, passes through the hot air discharge chamber 132 and the hot air exhaust hole 150, and is guided to the second exhaust duct 90. Then, the hot air passes through the second exhaust duct 90 and is exhausted to the outside of the main body 10 (operation S250).

When the drying of the laundry is completed (operation 260), the water filter drain valve 43 connected to the drain hole 160 is opened. If the drain hole 160 is connected to the drain pipe 41, the drain pump 40 is operated simultaneously with the opening of the drain hole 160, and discharges the water containing the lint in the water storage chamber 120 to the outside of the main body 10 (operation S270). When the discharge of the water is completed, the drying cycle is completed.

As is apparent from the above description, a water filter and a washing machine having the same in accordance with one embodiment do not use condensation water during washing and drying processes and thus reduce an amount of water consumed, and prevent air containing moisture from being reintroduced into a heater and thus raise electric safety of the heater.

Further, the water filter and the washing machine having the same in accordance with the embodiment allow hot air to pass through the water filter prior to exhaust of the hot air to the outside of the washing machine so as to collect lint, generated during the drying process, within the water filter, thereby preventing clogging of a drain hole due to use of the washing machine for a long time.

Although a few embodiments have been shown and described, it would be appreciated by those skilled in the art that changes may be made in these embodiments without departing from the principles and spirit of the invention, the scope of which is defined in the claims and their equivalents.

What is claimed is:

1. A washing machine comprising:
a main body;
a drum disposed within the main body;
an air supply duct disposed so as to be communicated with the drum, and supplying hot air to the inside of the drum;
a first exhaust duct communicated with the drum so as to exhaust the hot air from the drum;
a second exhaust duct to guide the hot air exhausted from the drum to the outside of the main body;
a filter case provided with a hot air introduction hole connected to the first exhaust duct and a hot air exhaust hole connected to the second exhaust duct;
a water storage chamber provided within the filter case; and
a hot air flow chamber provided within the filter case and communicated with the water storage chamber.

2. The washing machine according to claim 1, wherein the hot air introduction hole is formed through the upper surface of the hot air flow chamber, and guides the hot air introduced through the hot air introduction hole toward the upper surface of the water storage chamber.

3. The washing machine according to claim 1, wherein the hot air introduction hole is formed at one end of the hot air flow chamber and the hot air exhaust hole is formed at the other end of the hot air flow chamber so as to allow the hot air to flow from the one end of the hot air flow chamber to the other end of the hot air flow chamber.

4. The washing machine according to claim 1, wherein:
the hot air flow chamber includes a hot air introduction chamber provided with one side communicated with the hot air introduction hole, and a hot air discharge chamber provided with one side communicated with the hot air introduction chamber and the other side communicated with the hot air exhaust hole;
lower surfaces of the hot air introduction chamber and the hot air discharge chamber are opened to be communicated with the water storage chamber; and
a hot air vent is formed between the hot air introduction chamber and the hot air discharge chamber.

5. The washing machine according to claim 4, wherein a cross-sectional area of the hot air vent is smaller than a cross-sectional area of the hot air introduction hole.

6. The washing machine according to claim 4, wherein an inner upper surface of the hot air introduction chamber is inclined at a designated angle toward the water storage chamber so as to guide the hot air introduced through the hot air introduction hole toward the water storage chamber.

7. The washing machine according to claim 1, further comprising a drain hole formed through the water storage chamber to discharge water from the water storage chamber to the outside.

8. The washing machine according to claim 7, further comprising a drain pump to absorb washing water and then to discharge the washing water to the outside of the main body,
wherein the drain hole is connected to a washing water inlet of the drain pump.

9. The washing machine according to claim 7, further comprising a water filter drain valve connected with the drain hole.

10. The washing machine according to claim 9, wherein the drain pump absorbs the water stored in the water storage chamber and then discharges the water to the outside of the main body under the condition that the water filter drain valve is opened.

11. The washing machine according to claim 1, further comprising a water level adjustment hole formed through the hot air flow chamber and disposed around the water storage chamber.

12. The washing machine according to claim 1, further comprising at least one hot air guide grid fixed to the upper surface of the hot air flow chamber and extended toward the water storage chamber.

13. The washing machine according to claim 12, wherein the at least one hot air guide grid forms a vent path in the hot air flow chamber, the vent path provided with one side communicated with the hot air introduction hole and the other side communicated with the hot air exhaust hole and having a distance being at least longer than a rectilinear distance from the hot air introduction hole to the hot air exhaust hole.

14. The washing machine according to claim 12, wherein a lower surface of the at least one hot air guide grid is located at a higher position than the upper surface of the water storage chamber.

15. The washing machine according to claim 1, further comprising a plurality of water spray holes formed on the inner upper surface of the hot air flow chamber.

16. The washing machine according to claim 1, further comprising:
a heater disposed in the air supply duct to heat external air introduced into the air supply duct; and
an air blower fan disposed in the air supply duct to supply the hot air obtained by the heater to the inside of the drum.

17. A water filter for washing machines comprising:
a filter case forming an external appearance of the water filter;
a water storage chamber, an upper surface of which is opened, provided in the lower portion of the inside of the filter case;
a hot air flow chamber, a lower surface of which is opened, provided in the upper portion of the inside of the filter case;
a hot air introduction hole formed at one side of the hot air flow chamber; and
a hot air exhaust hole formed at the other side of the hot air flow chamber.

18. The water filter for washing machines according to claim 17, wherein:
the hot air flow chamber includes a hot air introduction chamber provided with one side communicated with the hot air introduction hole, and a hot air discharge chamber provided with one side communicated with the hot air introduction chamber and the other side communicated with the hot air exhaust hole;
lower surfaces of the hot air introduction chamber and the hot air discharge chamber are opened to be communicated with the water storage chamber; and
a hot air vent is formed between the hot air introduction chamber and the hot air discharge chamber.

19. The water filter for washing machines according to claim 18, wherein a cross-sectional area of the hot air vent is smaller than a cross-sectional area of the hot air introduction hole.

20. The water filter for washing machines according to claim 17, wherein an inner upper surface of the hot air introduction chamber is inclined at a designated angle toward the water storage chamber so as to guide the hot air introduced through the hot air introduction hole toward the water storage chamber.

21. The water filter for washing machines according to claim 17, further comprising a drain hole formed through the water storage chamber to discharge water from the water storage chamber to the outside.

22. The water filter for washing machines according to claim 17, further comprising at least one hot air guide grid fixed to the upper surface of the hot air flow chamber and extended toward the water storage chamber.

23. The water filter for washing machines according to claim 17, further comprising a plurality of water spray holes formed on the inner upper surface of the hot air flow chamber.

24. A control method of a drying cycle of a washing machine having a water filter to remove lint from hot air discharged from a drum, comprising:
closing a water filter drain valve connected to a drain hole of the water filter;
supplying water to the water filter through a water supply hole of the water filter; and
opening the water filter drain valve and operating a drain pump, when drying of laundry is completed, to discharge the water in the water filter to the outside of a main body of the washing machine.
